(19) United States
(12) Patent Application Publication
(10) Pub. No.: US 2026/0209450 A1
(43) Pub. Date: Jul. 23, 2026

(54) PRODUCTION METHOD OF A WIDE-AREA NANOCRYSTAL FILM

(71) Applicant: BILKENT UNIVERSITESI ULUSAL NANOTEKNOLOJI ARASTIRMA MERKEZI, Ankara (TR)

(72) Inventors: Evren MUTLUGUN, Ankara (TR); Yusuf KELESTEMUR, Ankara (TR); Hilmi Volkan DEMIR, Ankara (TR)

(73) Assignee: BILKENT UNIVERSITESI ULUSAL NANOTEKNOLOJI ARASTIRMA MERKEZI, Ankara (TR)

(21) Appl. No.: 19/138,332

(22) PCT Filed: Jan. 30, 2024
(86) PCT No.: PCT/TR2024/050072

§ 371 Date: Jun. 12, 2025

(30) Foreign Application Priority Data
Jan. 31, 2023 (TR) 2023/001106

(51) Int. Cl. C08J 5/18; B29C 48/00; B29C 48/08; C08J 3/20

(52) U.S. Cl. CPC C08J 5/18; B29C 48/022; C08J 3/201; B29C 48/0018; B29C 48/08; B29K 2995/0041

(57) ABSTRACT

The present invention relates to a method (100) for producing polymeric nanocrystal films in a wide area.

### TECHNICAL FIELD

The present invention relates to a method for producing polymeric nanocrystal films in a wide area.

### BACKGROUND OF THE INVENTION

In order to convert nanocrystals from the form wherein they are synthesized in a liquid state into a solid-state film, nanocrystals are mixed with different polymer materials and then converted into a film form. Before being converted into a polymeric film by means of blow extrusion, nanocrystals are added into an extrusion device in a solid form. Powdered nanocrystal can be loaded into a system by being mixed with a polymer granule, however a homogeneity issue and problem of incapability to be produced in a wide area are experienced in a nanocrystal film produced in this way.

Therefore, there is need for a novel method for producing polymeric nanocrystals homogeneously and in a wide area.

The United States patent document no. US2019088830, an application included in the state of the art, discloses a film consisting of nanocrystal and a matrix material. The nanocrystal included in the said film is a quantum dot comprising at least one of indium phosphide (InP), cadmium selenide (CdSe), zinc sulfide (ZnS), lead sulfide (PbS), indium arsenide (InAs), indium gallium phosphide, (InGaP), cadmium zinc selenide (CdZnSe) among examples of quantum dot or semiconducting material. Matrix material is an extrudable material comprising polymers and organic and inorganic oxides. Matrix material may be epoxies, acrylates, norbornene, polyethylene, poly(vinyl butyral):poly(vinyl acetate), polyurea, polyurethanes, polypropylene, polycarbonate, or a combination thereof. The said film includes process steps of mixing quantum dots and polymer—that may be polyethylene—homogeneously, extruding the mixture by introducing it into a hopper, turning the extruded mixture into a film form by passing it through chill rolls.

### SUMMARY OF THE INVENTION

An objective of the present invention is to realize a method for producing polymeric nanocrystal films in a wide area.

### DETAILED DESCRIPTION OF THE INVENTION

“A Production Method of A Wide-Area Nanocrystal Film” realized to fulfil the objective of the present invention is shown in the figure attached, in which:

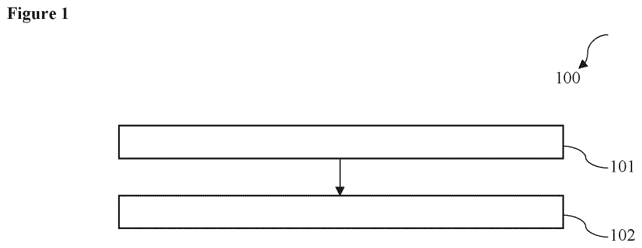

FIG. 1 is a flowchart of the inventive method.

### 100. METHOD

The inventive method (100) for producing polymeric nanocrystal films in a wide area comprises steps of
obtaining a homogeneous mixture by mixing a nanocrystalline in a liquid-state form, that is desired to be included in a polymeric film, with polymeric granules in a molten state (101); and
obtaining a polymeric nanocrystal with a desired width by loading the homogeneous mixture into a blow extrusion device (102).

At the step of obtaining a homogeneous mixture by mixing a nanocrystalline in a liquid-state form, that is desired to be included in a polymeric film, with polymeric granules in a molten state (101) of the inventive method (100), a quantum dot is combined with at least one nanocrystal in a liquid-state form—that is any of compounds being in a different type such as nanosheet and comprising Cd, In, Zn, Se, S, P—and at least one polymeric granule—that is an extrudable polymer such as low and high-volume polyethylene—in a container and the mixing process is carried out until a homogeneous mixture is obtained. The nanocrystal included in the homogeneous mixture is 1 mg-1000 g in scale, the polymeric granule is 1 kg-100 kg in scale, and the mixture ratios are 1:1000-1:1 by mass. The resulting homogeneous mixture is dried by being placed in a vacuum oven and kept here at a temperature of 20-200 ° C. for 1 minute-48 hours before being loaded into a blow extrusion device. The dried homogeneous mixture is converted into a powder granule form by being ground. In one embodiment of the invention, the nanocrystals used may be monochrome or in a form realizing multiple different radiations.

At the step of obtaining a polymeric nanocrystal with a desired width by loading the homogeneous mixture into a blow extrusion device (102) of the inventive method (100), the homogeneous mixture converted into a powder granule is loaded into a blow extrusion device with one or more channels and a polymeric film in desired diameters is obtained upon being blown up, by proceeding along a line at a temperature of 100-250° C. and varying the diameter of the output module of the extrusion device. Diameters of the polymeric films produced are controlled by the diameter of the balloon obtained during blow up. The polymeric films produced can be stored in a resizable form for different applications, by being wrapped in rolls.

In one embodiment of the invention, the drawing speed of polymeric film in the extrusion device is greater than 1 m²/hour.

With the inventive method (100), it is possible to obtain a wide-area nanocrystal polymeric film so as to be used in display technologies.

Within these basic concepts; it is possible to develop various embodiments of the inventive “Production Method (100) of A Wide-Area Nanocrystal Film”; the invention cannot be limited to examples disclosed herein and it is essentially according to claims.

1. A method (100) for producing polymeric nanocrystal films in a wide area; characterized in that it comprises steps of
obtaining a homogeneous mixture by mixing a nanocrystalline in a liquid-state form, that is desired to be included in a polymeric film, with poly meric granules in a molten state (101); and
obtaining a polymeric nanocrystal with a desired width by loading the homogeneous mixture into a blow extrusion device (102).

2. A method (100) according to claim 1; characterized in that at the step of obtaining a homogeneous mixture by mixing a nanocrystalline in a liquid-state form, that is desired to be included in a polymeric film, with polymeric granules in a molten state (101), a quantum dot is combined with at least one nanocrystal in a liquid-state form—that is any of compounds being in a different type such as nanosheet and comprising Cd, In, Zn, Se, S, P—and at least one polymeric granule—that is an extrudable polymer such as low and high-volume polyethylene—in a container and the mixing process is carried out until a homogeneous mixture is obtained.

3. A method (100) according to claim 1; characterized in that at the step of obtaining a homogeneous mixture by mixing a nanocrystalline in a liquid-state form, that is desired to be included in a polymeric film, with polymeric granules in a molten state (101), the nanocrystal included in the homogeneous mixture is 1 mg-1000 g in scale, the polymeric granule is 1 kg-100 kg in scale, and the mixture ratios are 1:1000-1:1 by mass.

4. A method (100) according to claim 1; characterized in that at the step of obtaining a homogeneous mixture by mixing a nanocrystalline in a liquid-state form, that is desired to be included in a polymeric film, with polymeric granules in a molten state (101), the resulting homogeneous mixture is dried by being placed in a vacuum oven and kept here at a temperature of 20-200 ° C. for 1 minute-48 hours before being loaded into a blow extrusion device.

5. A method (100) according to claim 4; characterized in that at the step of obtaining a homogeneous mixture by mixing a nanocrystalline in a liquid-state form, that is desired to be included in a polymeric film, with polymeric granules in a molten state (101), the dried homogeneous mixture is converted into a powder granule form by being ground.

6. A method (100) according to claim 1; characterized in that at the step of obtaining a polymeric nanocrystal with a desired width by loading the homogeneous mixture into a blow extrusion device (102); the homogeneous mixture converted into a powder granule is loaded into a blow extrusion device with one or more channels and a polymeric film in desired diameters is obtained upon being blown up, by proceeding along a line at a temperature of 100-250° C. and varying the diameter of the output module of the extrusion device.

7. A method (100) according to claim 6; characterized in that at the step of obtaining a polymeric nanocrystal with a desired width by loading the homogeneous mixture into a blow extrusion device (102); the drawing speed of polymeric film in the extrusion device is greater than 1m²/hour.
